(19) United States
(12) Patent Application Publication
(10) Pub. No.: US 2020/0367580 A1
(43) Pub. Date: Nov. 26, 2020

(54) COOLING APPARATUS

(71) Applicants: Jason Robarts, Simi Valley, CA (US); Paul Koch, Simi Valley, CA (US)

(72) Inventors: Jason Robarts, Simi Valley, CA (US); Paul Koch, Simi Valley, CA (US)

(21) Appl. No.: 16/422,885

(22) Filed: May 24, 2019

(51) Int. Cl. A41D 13/002; A41D 13/005; A41D 1/04; B32B 3/26; B32B 5/02; B32B 5/26

(52) U.S. Cl. CPC A41D 13/0025; A41D 13/0053; A41D 1/04; B32B 3/266; B32B 2250/20; B32B 5/26; A41D 2300/32; B32B 2437/00; B32B 2250/02; B32B 5/02

(57) ABSTRACT

The system comprises a cooling garment that is intended to cool the user of the garment. In one embodiment, the cooling garment is worn under a tactical vest. In one embodiment, the cooling garment is worn under any other garment or in any situation or environment where the user desires a cooling effect. In one embodiment the cooling garment comprises an outer layer and an inner layer. The inner layer has a plurality of perforations that allow air to flow therethrough. The outer layer is solid, so that air is urged toward the perforations and does not exit the garment away from the user, but instead towards the user. A flexible hose is coupled between the first and second layer and extends outward from the garment. The hose terminates in a quick release coupling that allows it to be removably attached to an air source, such as from a pump or other cooling system. In one embodiment, the quick release coupling is magnetic and is detached by pulling on the coupling or by the user of the cooling garment stepping away from the connection. In one embodiment, the system is used in a vehicle with a pump coupled to the electrical system of the vehicle.

### BACKGROUND OF THE SYSTEM

First responders and military personnel often are required to wear body armor as protection. Often this body armor is in the form of a ballistic or tactical vest (so called “bullet-proof” vest). The vest itself is not the protective portion, but rather it contains protective plates inserted into pockets and openings in the vest that provide the actual protection from projectiles and other blunt force attacks.

To be effective, body armor should be worn snugly so that the protective plates are in the right position to protect the most vulnerable locations. Once the user puts on the body armor, the body armor should not move around, which could cause repositioning of the protective plates.

The proper way to wear a tactical vest leads to the user typically being very warm in the vest, there is little or no ventilation in the vest so the user may sweat uncomfortably in the vest during use. This heat and sweating can cause responders to avoid using the vest, even when its use is required. It can also cause responders to wear the vest more loosely to allow ventilation, defeating the purpose of the vest.

There is a desire to make the vest more comfortable when worn, particularly to provide ventilation and or cooling to the user during use. There have been a number of attempts to provide cooling for tactical vests in the current art. One attempt has been the use of a mesh garment to be worn under the vest to provide ventilation and airflow. However, the mesh garment is passive and does not provide actual cooling or active airflow for the user.

Another prior art attempt is a garment that is soaked in cold water for a few minutes before use. The evaporation of the water in the material is intended to provide a cooling effect for the user. However, most users do not want to put wet garments on and it is not effective without re-soaking the garment, which is not always possible to do.

Another attempt is a hose with a “U-shaped” nozzle that is inserted into the back of the neck of the vest, with another end positioned over an air-conditioning vent of a vehicle. A disadvantage of this system is that any cooling air is directed in only a single location of the body, and the system is not efficient in capturing cool air from many typical air conditioning vents.

### SUMMARY

The system comprises a cooling garment that is intended to cool the user of the garment. In one embodiment, the cooling garment is worn under a tactical vest. In one embodiment, the cooling garment is worn under any other garment or in any situation or environment where the user desires a cooling effect. In one embodiment the cooling garment comprises an outer layer and an inner layer. The inner layer has a plurality of perforations that allow air to flow therethrough. The outer layer is solid, so that air is urged toward the perforations and does not exit the garment away from the user, but instead towards the user. A flexible hose is coupled between the first and second layer and extends outward from the garment. The hose terminates in a quick release coupling that allows it to be removably attached to an air source, such as from a pump or other cooling system. In one embodiment, the quick release coupling is magnetic and is detached by pulling on the coupling or by the user of the cooling garment stepping away from the connection. In one embodiment, the system is used in a vehicle with a pump coupled to the electrical system of the vehicle.

### BRIEF DESCRIPTION OF THE DRAWINGS

FIG. 1 is a front view of a cooling garment in an embodiment of the system.

FIG. 2 is a rear view of the cooling garment of FIG. 1.

FIG. 3 is a view of the inner front surface of the cooling garment of FIG. 1.

FIG. 4 is a view of the inner rear surface of the cooling garment of FIG. 1.

FIG. 5 illustrates a hose, coupling, and pump in an embodiment of the system.

FIG. 6 illustrates a cross sectional view of the garment 100.

### DETAILED DESCRIPTION OF THE SYSTEM

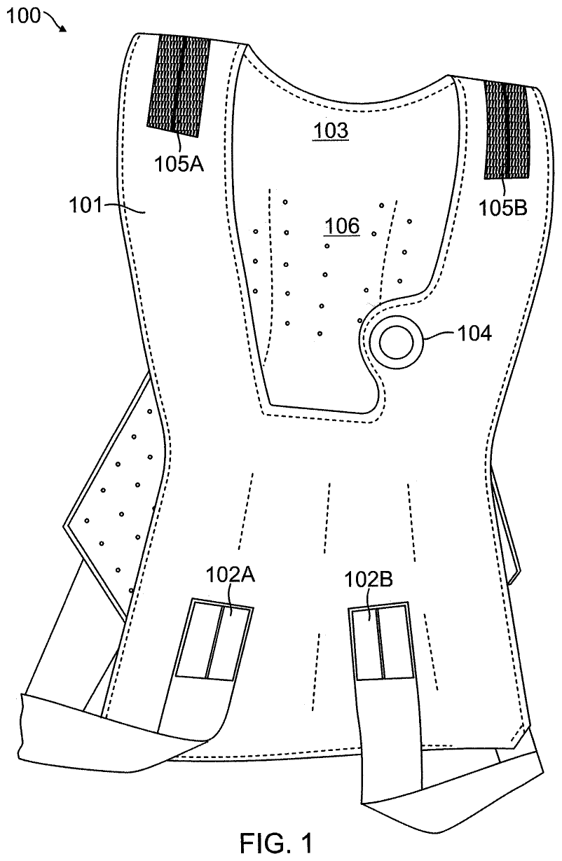

The system provides a cooling garment that can be coupled to an air source and easily decoupled and recoupled as desired. The cooling garment provides consistent ventilation over the inner surface of the garment, keeping the user cool and dry over a variety of environmental conditions. FIG. 1 is a front view of a cooling garment in an embodiment of the system. The garment 100 in this embodiment is a tunic style garment that has a large opening so that it can be pulled on over the head. The garment 100 includes a front layer 101 and rear layer 103. The layers are coupled together so that there is a gap (not shown) between the layers 101 and 103 to allow air flow. The garment 100 includes straps 102A and 102B for securing the front and rear portions together at the waist so that the garment 100 is securely in place. Optional shoulder Velcro™ regions 105A and 106A so that a tactical vest with corresponding Velcro™ r4egions can secure to the garment 100, helping to keep it in place.

The rear layer 103 includes a plurality of perforations 106 that allow air to be introduced to the user when the garment is worn. The gap between the front layer 101 and rear layer 103 expands somewhat as air is introduced to that region, permitting greater airflow via the perforations. A coupling 104 is used to couple a hose to the garment. The hose is coupled to an air source such as an air pump and introduces flowing air to the garment 100.

In one embodiment the coupling 104 is an “O” shaped ring that is magnetic and has an opening in the middle through which air is introduced. The magnetic ring engages a corresponding magnetic ring on the hose to hold the hose securely in place without the need for clips or locks. This magnetic coupling makes it easier to couple and uncouple the hose quickly, in case the user needs to move quickly and to separate from the hose. In the embodiment shown, the coupling is placed near the chest area of the garment. In one embodiment, the coupling 104 is placed on the front or rear shoulder strap of the garment. The coupling 104 may be placed where ever convenient for use and access.

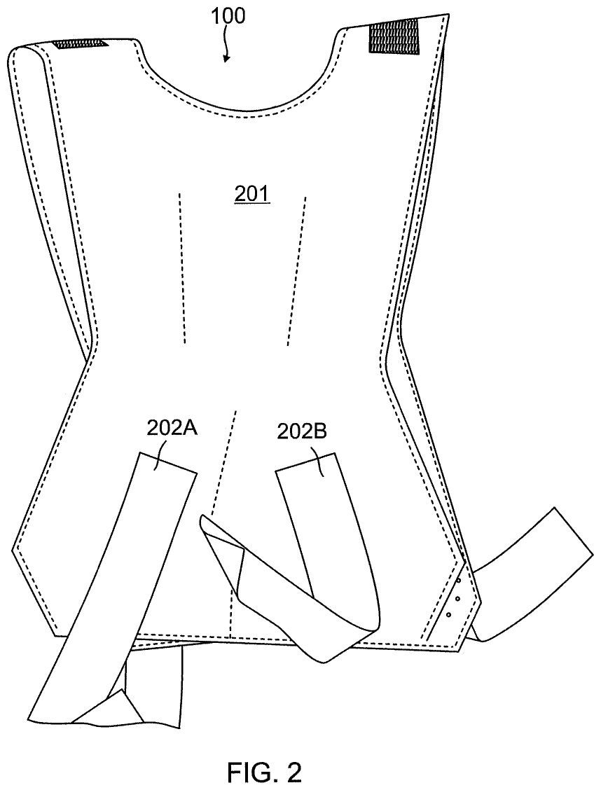

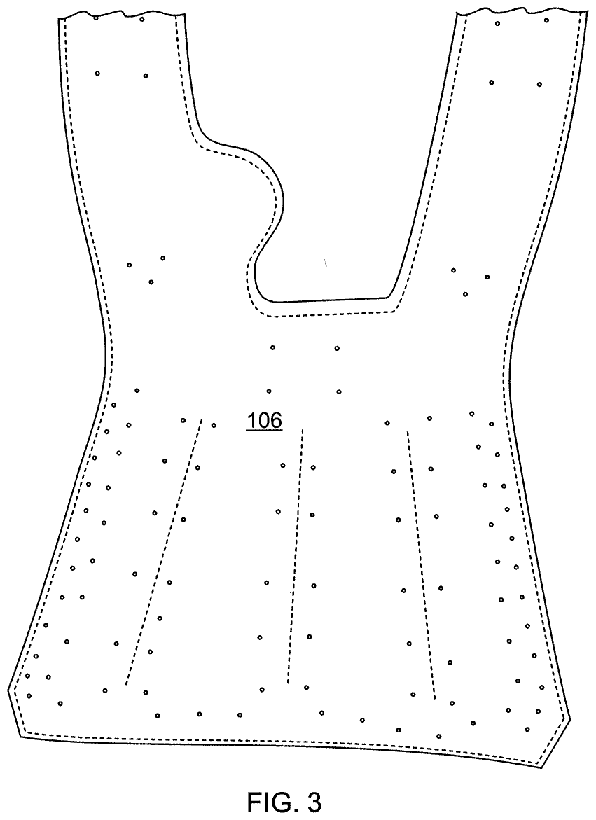

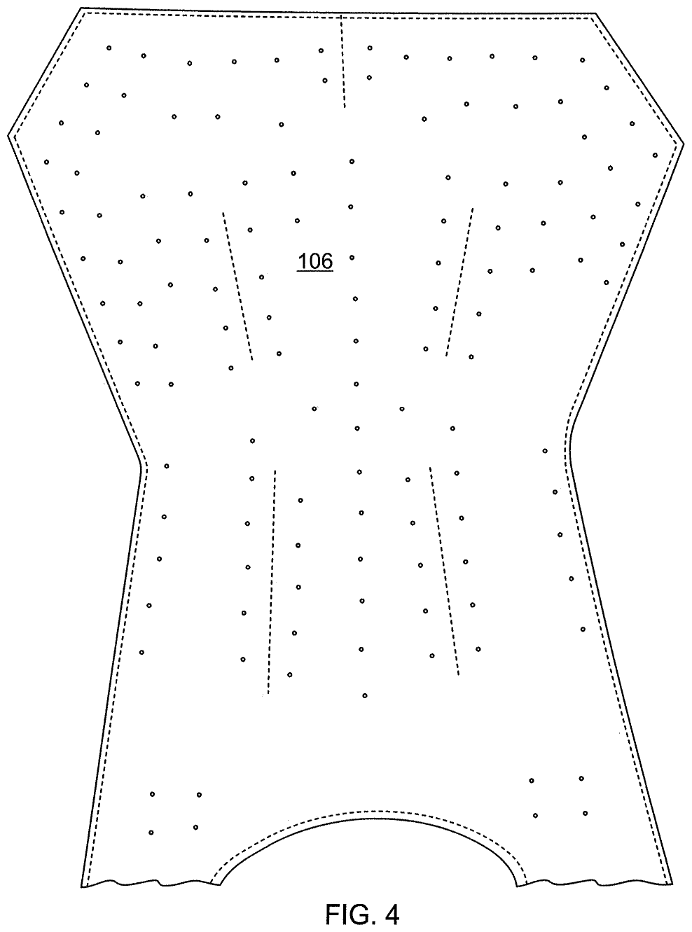

FIG. 2 is a rear view of garment 100 and illustrates the back surface 201 with adjusting straps 202A and 202B. Although shown as a tunic style garment, the garment may be of any suitable style as desired. FIG. 3 illustrates the inner surface 301 of the front layer 101 of the garment 100. The inner surface 301 includes a plurality of perforations 106 that provide airflow via the coupling 104. In one embodiment, the front layer 101 and rear layer 103 may be coupled only on the outside edge, so that there is one large pocket formed by the two layers. In one embodiment, there are channels formed within the gap between the layers by sewing, gluing, and the like, to direct the airflow through the channels to the perforations. The perforations may be formed in a pattern and distributed evenly over the inner surface, or they may be in rows and/or columns to define areas of airflow on the user. FIG. 4 illustrates the inner surface 103 of the rear portion of the garment 100 and the perforations 106.

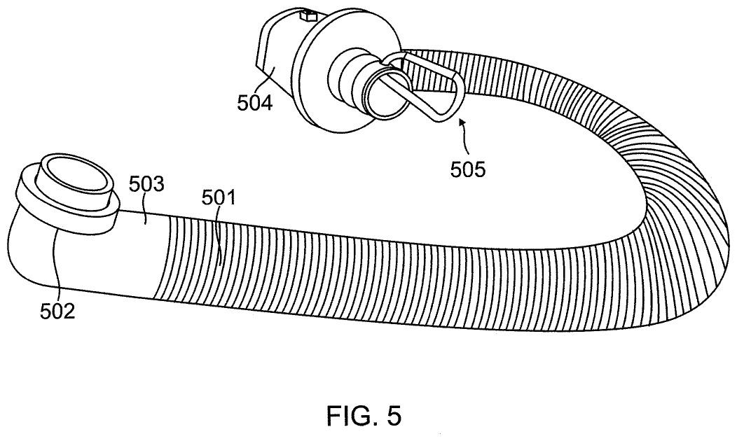

FIG. 5 illustrates a hose and pump assembly in an embodiment of the system. A hose (e.g. flex hose) 501 is coupled to a pump 504. The pump 504 may be any suitable pump that can pump air into the hose at an acceptable rate. In one embodiment the pump 504 is powered by an adapter plugged into a cigarette lighter socket in a vehicle. In one embodiment, the pump may be coupled to the vehicle electrical system in some other manner. The pump 504 may be designed so that when the vehicle power is on, the pump automatically turns on as well. Correspondingly, when the vehicle power is turned off, the pump is turned off. In one embodiment, the pump may have a separate on/off switch that can be activated by the user. In one embodiment, the pump may be operated via a remote control for more ease of use. Examples of suitable pumps include (JASON PLEASE ADVISE OF WHAT PUMPS CAN WORK)

The hose 501 includes a right-angled end 502 for engaging the coupling 104 of the garment 100. The end 502 includes hose coupling ring 503. The hose coupling ring 503 engages the coupling ring 104 of the garment 100 to secure the hose in place so that air flow is maximized into the garment 100. In one embodiment, both the coupler 104 and the hose coupling ring 503 are magnetic. In one embodiment, one of the coupling ring 104 and the hose coupling ring 503 is magnetic while the other is metallic. The strength of the magnetic connection should be such that the hose remains securely in place during use but can be easily disconnected by hand if the user needs to quickly disengage the cooling garment system.

Although the garment 100 is shown with the coupling ring 104 flush with the surface of the garment 100, the system may be practiced in other variations. For example, the garment 100 could have a short length of hose extending from some location on the garment with the coupling 104 at the end of that short length of hose. The short hose can then engage the pump hose 501 outside the boundaries of the garment 100.

In one embodiment the short hose extends from a shoulder of the garment 100 to reduce interference with the device when sitting in a vehicle.

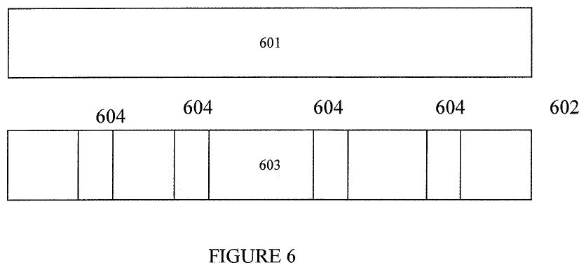

FIG. 6 is a cross sectional view of an embodiment of the garment. Upper layer 601 is comprised of a fabric such as canvas, cotton, and the like (JASON, WHAT IS BEST TOP FABRIC?) There is a gap 602 between the upper layer 601 and the bottom layer 603. Gap 602 permits the flow of air throughout the interior of the garment when in use. Bottom layer 603 includes a plurality of perforations 604 that allow air to flow from gap 602 to impinge on the user. In one embodiment, bottom layer 603 is comprised of (JASON, WHAT IS IDEAL MATERIAL FOR BOTTOM LAYER?). In one embodiment, the bottom layer is approximately ______ mils in thickness.

What is claimed is:

1. A garment comprising:
a first layer comprising a first material;
a second layer comprising a second material;
the first and second layer coupled together such that a space is defined therebetween;
the second layer having a plurality of perforations formed therein;
the first layer including a first coupling;
a pump having an air hose wherein the air hose has a second coupling at an end of the air hose;
the hose being attached to the first coupling via the second coupling.
